(19) United States
(12) Patent Application Publication
(10) Pub. No.: US 2026/0309232 A1
(43) Pub. Date: Oct. 8, 2026

(54) CLUTCH ASSEMBLY FOR UTILITY TERRAIN VEHICLES

(71) Applicant: Robby Gordon, CONCORD, NC (US)

(72) Inventor: Robby Gordon, CONCORD, NC (US)

(21) Appl. No.: 19/640,356

(22) Filed: Apr. 6, 2026

Related U.S. Application Data
(60) Provisional application No. 63/783,650, filed on Apr. 4, 2025.

(51) Int. Cl. F16J 15/3268; B60S 5/00

(52) U.S. Cl. CPC F16J 15/3268; B60S 5/00; F16D 2250/0084; F16D 2300/06; F16D 2300/08; F16D 2300/12; F16D 2300/26

(57) ABSTRACT

A clutch assembly for a vehicle includes a primary clutch assembly and a secondary clutch assembly, each having multiple subassemblies. Each subassembly includes a bushing configured to support relative movement between components, at least one pair of wiper seals positioned on opposing sides of the bushing to reduce ingress of contaminants and retain lubrication, and an axial retention element configured to maintain the position of the bushing and seals during operation.

### CROSS REFERENCE TO RELATED APPLICATIONS

This application claims priority from a U.S. Provisional Patent Appl. No. 63/783,650, filed on Apr. 4, 2025, which is incorporated herein by reference in its entirety.

### FIELD OF INVENTION

The present invention relates to clutch assembly and utility terrain vehicles, and more particularly, the present invention relates to enhanced clutch assembly for utility terrain vehicles with integrated wiper seal, bushing, and spiral lock features.

### BACKGROUND

Utility terrain vehicles (UTVs) are frequently operated in harsh and demanding environments, including exposure to dirt, sand, mud, water, and high torque loads. These conditions impose significant mechanical and environmental stress on drivetrain components, particularly clutch assemblies used to transfer power between engine and transmission systems.

Conventional clutch assemblies typically lack adequate sealing at critical interfaces, including between rotating members and supporting bushings. As a result, contaminants such as dust, abrasive particles, and moisture may infiltrate the assembly, leading to accelerated wear, increased friction, and degradation of performance over time.

In addition, many traditional clutch designs rely on press-fit or loosely retained bushings without dedicated axial retention mechanisms. This may result in bushing displacement, component misalignment, and uneven load distribution during operation, which can further contribute to premature failure and reduced operational efficiency.

Furthermore, existing clutch assemblies are often not configured for modular servicing. Replacement of worn components such as bushings or seals may require disassembly of the entire clutch unit, increasing maintenance time and cost. The absence of integrated sealing and retention features within sub-assemblies further limits durability and serviceability.

Accordingly, there remains a need for an improved clutch assembly for utility terrain vehicles that provide enhanced environmental sealing, reliable axial retention of bushings, and a modular configuration that facilitates efficient servicing and improved durability under demanding operating conditions.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

In one aspect, a modular clutch assembly is disclosed that integrates bushings within each clutch subassembly, at least one pair of wiper seals configured to reduce contamination and retain lubrication, and spiral lock elements configured to axially retain the bushings under operational loads.

The modular clutch assembly is applicable to both primary and secondary clutch assemblies and is configured to improve resistance to environmental contamination, maintain alignment of rotating components, and reduce wear during operation.

The combination of sealed bushing interfaces and axial retention elements further facilitates modular servicing, enabling replacement of individual components without disassembly of the entire clutch assembly, thereby improving maintenance efficiency and extending service life.

The clutch assembly is configured for operation in harsh environments. The disclosed clutch assembly is particularly suited for use in utility terrain vehicles (UTVs), off-road vehicles, and other applications exposed to contaminants and high mechanical loads.

In one aspect, the clutch assembly includes a modular architecture incorporating bushings, sealing elements, and axial retention mechanisms within multiple subassemblies. Each bushing is positioned within a respective subassembly and is sealed by at least one pair of wiper seals and retained by a spiral lock element.

The integration of bushings, wiper seals, and spiral lock retention elements provides improved resistance to contamination, enhanced lubrication retention, and reliable axial positioning of components under operational loads.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 illustrates an exploded perspective view of a primary clutch assembly, including a top hat sub-assembly and a basket sub-assembly, and further showing associated bushings, spiral lock retention elements, and wiper seals, in accordance with an exemplary embodiment of the present invention.

FIG. 2 illustrates an exploded perspective view of a secondary clutch assembly, including a helix sub-assembly, an inner sheave sub-assembly, and a secondary post, and further showing associated bushings, spiral lock retention elements, and wiper seals, in accordance with an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

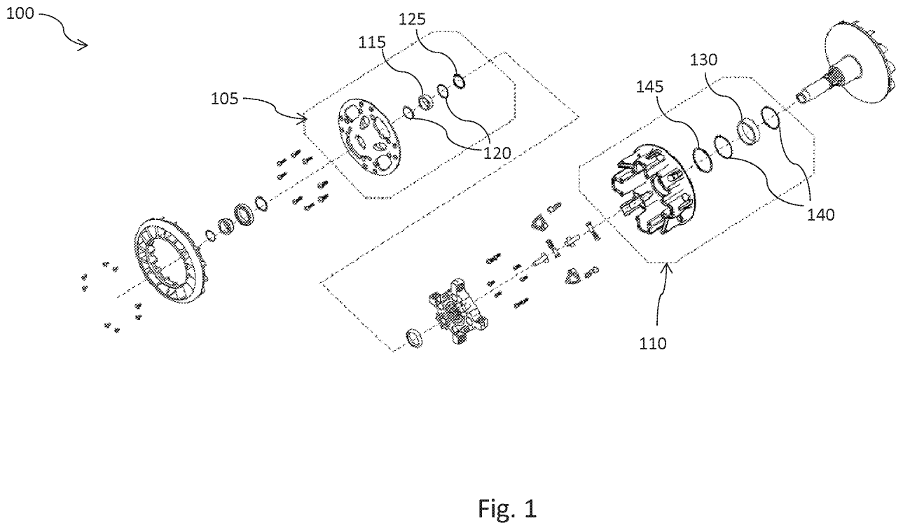

Referring to FIG. 1, a primary clutch assembly 100 includes a top hat subassembly 105 and a basket subassembly 110. The top hat subassembly 105 includes a bushing 115 configured to permit rotational motion while maintaining concentric alignment. At least one pair of wiper seals 120 is positioned on opposing sides of the bushing 115 to inhibit ingress of contaminants and retain lubrication. A spiral lock element 125 is configured to axially retain the bushing 115 and associated wiper seals 120 within the subassembly.

The basket subassembly 110 similarly includes a bushing 130, at least one pair of wiper seals 140, and a spiral lock element 145 configured to retain the bushing and seals. This arrangement supports alignment of rotating components during operation.

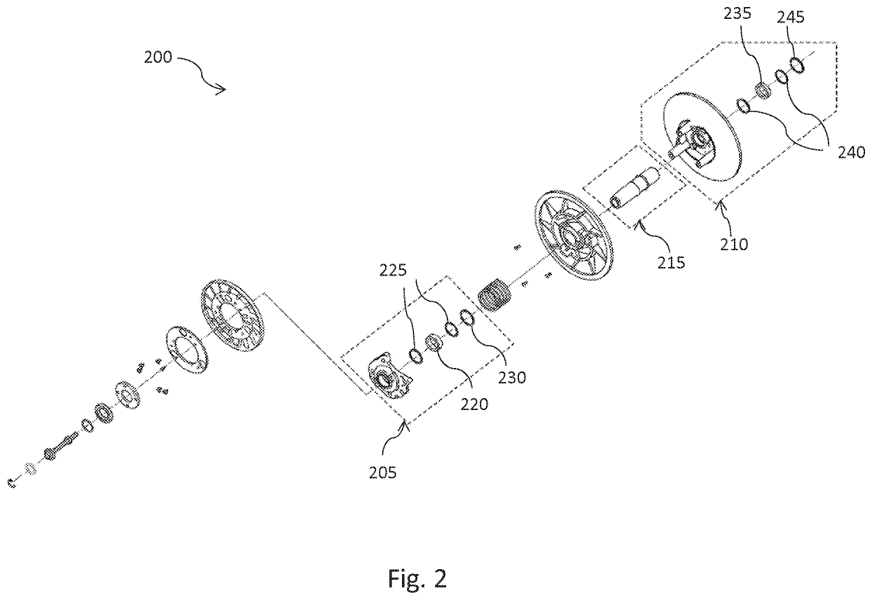

Referring to FIG. 2, a secondary clutch assembly 200 includes a helix subassembly 205, an inner sheave subassembly 210, and a secondary post 215. The helix subassembly 205 includes a bushing 220, at least one pair of wiper seals 225 positioned on opposite sides of the bushing, and a spiral lock element 230 configured to retain the bushing and seals.

The inner sheave subassembly 210 is mounted coaxially on the secondary post 215 and includes a bushing 235, at least one pair of wiper seals 240, and a spiral lock element 245. The inner sheave subassembly is configured for axial translation relative to the secondary post during operation. The secondary post 215 is configured to transmit rotational torque and interface with the inner sheave subassembly through the bushing and seal arrangement.

In operation, the clutch assembly is configured to transmit torque between an engine and a driven system through coordinated movement of the primary and secondary clutch assemblies. The primary clutch assembly is responsive to engine speed, while the secondary clutch assembly responds to torque load and belt tension, thereby enabling dynamic ratio adjustment during operation.

The bushings disposed within each subassembly provide a low-friction interface between relatively rotating or sliding components. In particular, each bushing is dimensioned to maintain concentric alignment between mating components, thereby reducing vibration, uneven wear, and energy loss during operation.

The wiper seals positioned on opposing sides of each bushing form a contamination barrier that limits ingress of particulate matter such as dust, sand, mud, and moisture. In addition, the wiper seals function to retain lubricants within the bushing interface region, thereby maintaining consistent lubrication over extended operating periods.

In certain embodiments, the dual wiper seal configuration creates a sealed cavity around the bushing. This cavity may retain grease or other lubricants, forming a self-contained lubrication zone that reduces the need for frequent maintenance and enhances durability under high-load conditions.

The spiral lock elements are configured to engage corresponding grooves formed in the clutch components. Once installed, the spiral lock elements provide axial retention of the bushings and associated seals, preventing displacement during operation. This retention is particularly advantageous under conditions of vibration, shock loading, and repeated axial movement of clutch components.

In contrast to press-fit retention methods, the spiral lock configuration allows controlled installation and removal of components without deformation of surrounding structures. This facilitates repeatable servicing and reduces the risk of component damage during maintenance.

The modular configuration of the clutch assembly enables individual subassemblies to be independently serviced or replaced. For example, a worn bushing and associated seals within a single subassembly may be replaced without disassembling the entire clutch system. This modularity reduces maintenance time and cost while improving service accessibility.

In some embodiments, the bushings, seals, and retention elements may be preassembled into cartridge-style units configured for insertion into corresponding clutch subassemblies. Such cartridge configurations may simplify manufacturing, improve assembly consistency, and reduce installation errors.

The inner sheave subassembly of the secondary clutch is configured to translate axially relative to the secondary post in response to belt forces and torque conditions. The sealed bushing arrangement maintains smooth axial sliding motion while preventing contamination from impairing movement.

The helix subassembly may include cam surfaces configured to convert rotational torque into axial displacement. The sealed bushing interface within the helix subassembly reduces frictional losses and ensures consistent torque sensing behavior.

In certain embodiments, the sealing system may include additional features such as labyrinth seal geometries, dust lips, grease channels or reservoirs, or pressure-relief pathways. These features may be used individually or in combination with the wiper seals to further enhance environmental protection.

The spiral lock elements may be continuous or multi-turn ring structures and may include features such as radial expansion bias, locking tabs, or anti-rotation features. Such configurations may improve retention reliability under extreme operating conditions.

In alternative embodiments, the axial retention function may be achieved using snap rings, circlips, threaded retainers, or integral shoulders formed within the clutch components.

The number and configuration of seals may vary depending on application requirements. While dual wiper seals are preferred, certain embodiments may utilize a single seal for reduced friction or multiple seals for enhanced protection.

The clutch assembly components may be manufactured using machining, casting, forging, or additive manufacturing techniques. Surface treatments such as anodizing, nitriding, or coating with low-friction materials may be applied to improve wear resistance and corrosion protection.

In some embodiments, the bushings may include embedded solid lubricants or surface texturing to further reduce friction and improve lubrication retention.

The disclosed clutch assembly is particularly advantageous in environments involving high particulate exposure, frequent load variations, and extended duty cycles. The combination of sealing, retention, and modularity results in improved operational reliability and reduced lifecycle costs.

In certain embodiments, the combination of the bushings, wiper seals, and spiral lock elements provides a cooperative effect in which sealing, lubrication retention, and axial positioning are maintained concurrently during operation. The wiper seals inhibit ingress of contaminants and preserve a lubricated interface at the bushing, while the spiral lock elements maintain positional stability of the bushing and seals under dynamic loading. This integrated arrangement enables sustained alignment and reduced friction between moving components, resulting in improved operational efficiency and durability beyond that achievable by the individual components acting independently.

The bushings may be formed from materials including bronze, sintered metal, or polymer composites exhibiting low friction and wear resistance. The wiper seals may be formed from elastomeric materials including nitrile rubber (NBR), fluorocarbon, or polyurethane. The spiral lock elements may be formed from spring steel or alloyed wire and configured to engage grooves within corresponding components.

In certain embodiments, alternative retention elements such as snap rings or retaining plates may be used. The sealing configuration may include single, dual, or multiple seals depending on application requirements.

In some implementations, bushings and seals may be integrated into a composite sleeve assembly.

The disclosed clutch assembly may be used in utility terrain vehicles, all-terrain vehicles, snowmobiles, motorcycles, agricultural equipment, and industrial machinery.

The combination of sealed bushings and axial retention elements provides improved resistance to contamination, reduced wear, improved alignment, and enhanced durability. The modular configuration facilitates servicing and replacement of individual components.

While the foregoing description sets forth what is presently considered to be the best mode of carrying out the invention, it will be understood by those skilled in the art that various modifications, combinations, substitutions, and equivalents may be made without departing from the scope and spirit of the invention. Accordingly, the invention is not to be limited by the specific embodiments, methods, or examples described herein, but is defined by the full scope of the appended claims and any legal equivalents thereof.

What is claimed is:

1. A clutch assembly, comprising:
a primary clutch assembly including a plurality of subassemblies;
a secondary clutch assembly including a plurality of subassemblies;
wherein each of the subassemblies of the primary and secondary clutch assemblies comprises:
a bushing configured to support relative movement between components;
at least one pair of wiper seals positioned on opposing sides of the bushing and configured to reduce ingress of contaminants and retain lubrication; and
an axial retention element configured to retain the bushing and the at least one pair of wiper seals within the subassembly during operation.

2. The clutch assembly of claim 1, wherein the axial retention element comprises a spiral lock element.

3. The clutch assembly of claim 1, wherein each subassembly includes exactly one pair of wiper seals positioned on opposite axial sides of the bushing.

4. The clutch assembly of claim 1, wherein the bushing is configured to maintain concentric alignment between relatively movable components.

5. The clutch assembly of claim 1, wherein the primary clutch assembly comprises:
a top hat subassembly; and
a basket subassembly,
each including a respective bushing, at least one pair of wiper seals, and an axial retention element.

6. The clutch assembly of claim 1, wherein the secondary clutch assembly comprises:
a helix subassembly;
an inner sheave subassembly; and
a secondary post.

7. The clutch assembly of claim 6, wherein the inner sheave subassembly is mounted coaxially on the secondary post and is configured for axial translation relative to the secondary post.

8. The clutch assembly of claim 1, wherein the at least one pair of wiper seals and the axial retention element cooperate to maintain lubrication and positional stability of the bushing during operation.

9. A method of assembling a clutch assembly, comprising:
providing a clutch subassembly configured to receive a bushing;
installing a bushing within the subassembly;
positioning at least one pair of wiper seals on opposing sides of the bushing; and
retaining the bushing and the at least one pair of wiper seals within the subassembly using an axial retention element.

10. A method of servicing a clutch assembly, comprising:
removing an axial retention element from a clutch subassembly;
removing a bushing and at least one pair of wiper seals;
installing replacement components; and
reinstalling the axial retention element to secure the replacement components.
